(19) United States
(12) Patent Application Publication
(10) Pub. No.: US 2026/0366433 A1
(43) Pub. Date: Nov. 19, 2026

(54) ASSEMBLY FOR A TURBINE ENGINE, COMPRISING A SEALING ELEMENT, AND SEALING ELEMENT FOR SUCH AN ASSEMBLY FOR A TURBINE ENGINE

(71) Applicant: SAFRAN AIRCRAFT ENGINES, Paris (FR)

(72) Inventors: Emmanuel Linquette, Moissy-Cramayel (FR); Thomas Laurent Frederic Gauduchon, Moissy-Cramayel (FR)

(73) Assignee: SAFRAN AIRCRAFT ENGINES, Paris (FR)

(21) Appl. No.: 19/480,157

(22) PCT Filed: May 24, 2024
(86) PCT No.: PCT/FR2024/050671

§ 371 Date: Oct. 30, 2025

(30) Foreign Application Priority Data
May 26, 2023 (FR) FR2305287

(51) Int. Cl. F01D 11/00; F01D 25/24

(52) U.S. Cl. CPC F01D 11/003; F01D 25/246; F05D 2240/11

(57) ABSTRACT

This turbomachine assembly comprises a first casing, a second casing, an abradable ring support carried by the first casing, an annular seal positioned between the first casing and the second casing, and a sealing element at least partly disposed between the annular seal and the second casing, the sealing element comprising an annular component provided with a first face in contact with the annular seal, and a second face opposite to the first face and in contact with the second casing.

### TECHNICAL FIELD

The technical field of the invention is sealing of a turbomachine, specially sealing of an air flux of a path in the turbomachine at the junction between two casings of the turbomachine.

In particular, one object of the present invention is a turbomachine assembly comprising a sealing element and a sealing element for such a turbomachine assembly.

### PRIOR ART

A turbomachine comprises a turbine with several turbine stages and a turbine casing. Each turbine stage comprises an annular row of fixed vanes and an annular row of moving vanes rotating inside the casing. The fixed vanes each comprise an inner platform and an outer platform that define a flow path for hot gases from an upstream combustion chamber located of the turbomachine. The moving vanes each comprise an inner platform.

The turbomachine comprises a downstream exhaust casing and a seal positioned at the junction between the exhaust casing and the turbine casing in order to ensure sealing, particularly thermal sealing, of this junction.

Rotating components of the turbomachine, temperature fluctuations experienced by different elements of the turbomachine, and gas pressures give rise to relative movements of the seal in relation to the turbine casing and/or the exhaust casing. These relative movements generate premature wear of the seal and/or turbine casing and/or exhaust casing. This premature wear degrades sealing of the junction between the exhaust casing and the turbine casing, degrades efficiency of the turbomachine, and gives rise to high maintenance costs.

### DISCLOSURE OF THE INVENTION

The objective of the present invention is therefore to overcome all or part of the aforementioned drawbacks.

One object of the present invention is a turbomachine assembly, the assembly comprising a first casing, a second casing, an abradable ring support carried by the first casing, an annular seal at least partly disposed between the abradable ring support and the second casing, and a sealing element at least partly disposed between the annular seal and the second casing, the sealing element comprising an annular component provided with a first face in contact with the annular seal, and provided with a second face opposite to the first face in contact with the second casing.

The sealing element in contact with the annular seal and the second casing makes it possible to increase compression of the annular seal, improve efficiency of the sealing function of the annular seal, and protect the second casing from wear caused by the movement of the annular seal. The cost of replacing the sealing element is also lower than the cost of replacing the second casing. The replacement time of the sealing element is also shorter than the replacement time of the second casing.

Preferably, the turbomachine assembly comprises a turbine, especially a low-pressure turbine.

In one particular embodiment, the first casing is a casing surrounding the turbine in the circumferential direction, while the second casing is a casing upstream or downstream of said turbine.

Advantageously, the sealing element comprises a nickel-based alloy.

The sealing element may comprise at least one large-diameter centring portion at least axially extending from a large-diameter edge of the annular component.

Said large-diameter centring portion may be in contact with the first casing.

The sealing element may comprise at least one small-diameter centring portion at least axially extending from a small-diameter edge of the annular component.

Said small-diameter centring portion may be in contact with the second casing.

In one embodiment, the large-diameter centring portion at least axially extends from the large-diameter edge of the annular component along a first direction, while the small-diameter centring portion at least axially extends from the small-diameter edge of the annular component along a second direction, with the first direction being opposite to the second direction.

According to one particular design, the sealing element further comprises an additional annular component that is connected to the annular component by said small-diameter centring portion, and which extends away from and facing the annular component.

Preferably, the additional annular component is in contact with the second casing.

Advantageously, the annular component comprises a thickened section, the additional annular component also comprising a thickened section, these thickened sections locally reducing the distance between the annular component and the additional annular component.

Optionally, the first casing is a low-pressure turbine casing for a turbomachine.

Optionally, the second casing is an exhaust casing for a turbomachine.

Advantageously, the turbomachine assembly comprises an abradable ring mounted to the abradable ring support, the annular seal comprising at least two convolutions and partly circumferentially surrounding the abradable ring.

Another object of the present invention is a sealing element adapted for a turbomachine assembly as previously defined, the sealing element being intended to be at least partly disposed between the annular seal and the second casing, the sealing element comprising an annular component provided with a first face intended to be in contact with the annular seal, and provided with a second face opposite to the first face and intended to be in contact with the second casing.

According to one first design, the sealing element comprises at least one first centring portion at least axially extending from a large-diameter edge of the annular component along a first direction, and at least one second centring portion at least axially extending from a small-diameter edge of the annular component along a second direction, with the first direction being opposite to the second direction.

According to a second design, the sealing element comprises at least one small-diameter centring portion at least axially extending from a small-diameter edge of the annular component, and an additional annular component which is connected to the annular component by said small-diameter centring portion, which extends away from and facing the annular component.

Advantageously, the annular component comprises a thickened section, the additional annular component also comprising a thickened section, these thickened sections locally reducing the distance between the annular component and the additional annular component.

Said sealing element is, for example, a spare part.

Another object of the present invention is a turbomachine comprising a turbomachine assembly as defined previously.

Another object of the present invention is an aircraft comprising a turbomachine assembly as defined previously.

### BRIEF DESCRIPTION OF THE DRAWINGS

Other aims, characteristics and advantages of the invention will become apparent upon reading the following description, given solely by way of non-limiting example and with reference to the appended drawings in which:

FIG. 1 schematically illustrates a turbomachine comprising an assembly for a turbomachine according to the invention;

FIG. 2 schematically illustrates a flow path of a low-pressure turbine in the turbomachine of FIG. 1;

FIG. 3 is an enlarged view of a part of FIG. 2, centred on a sealing element according to the invention;

FIG. 4 schematically illustrates a sealing element according to the invention;

FIG. 5 is a view corresponding to FIG. 3 according to a second exemplary embodiment of the invention; and

FIG. 6 schematically illustrates a sealing element according to a third exemplary embodiment of the invention.

### DETAILED DESCRIPTION

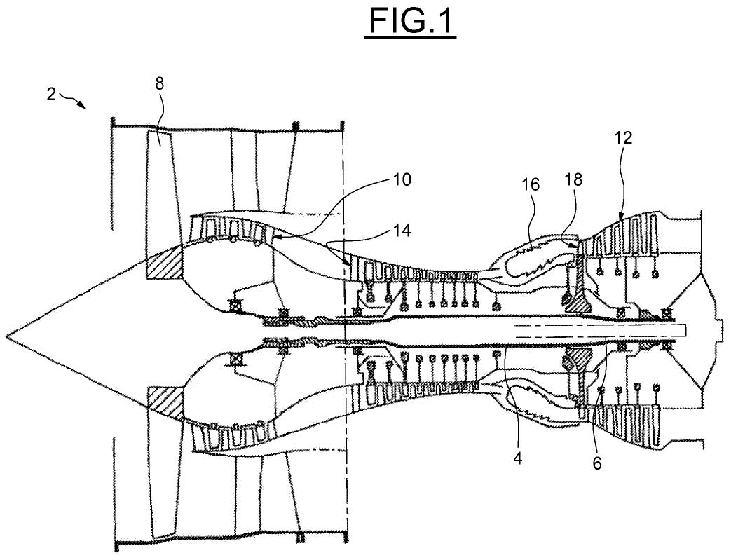

FIG. 1 schematically represents an aircraft turbomachine 2 comprising a low-pressure spool including a first shaft 4 and a high-pressure spool including a second shaft 6, the second shaft 6 being concentric to the first shaft 4.

The low-pressure spool comprises a fan 8, a low-pressure compressor 10 and a low-pressure turbine 12.

The high-pressure spool comprises a high-pressure compressor 14, a combustion chamber 16 and a high-pressure turbine 18.

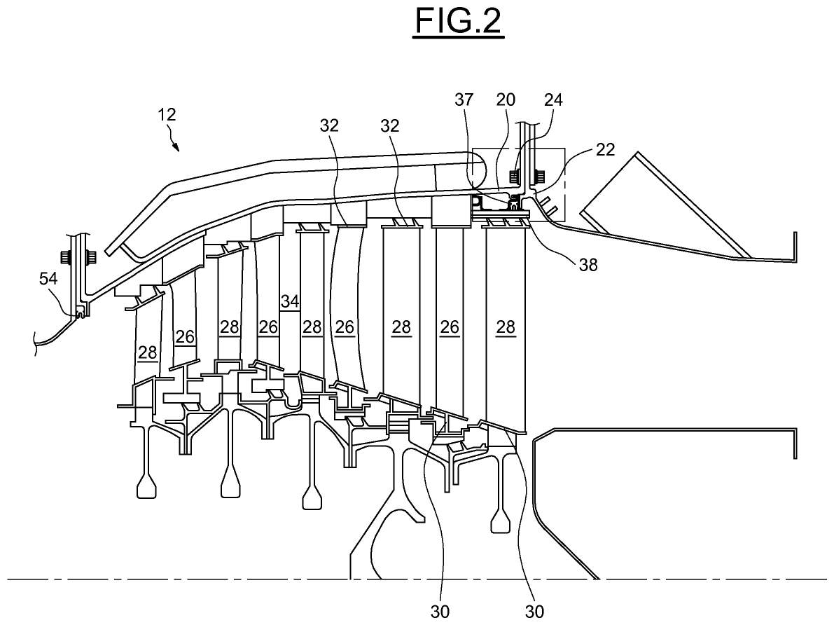

FIG. 2 schematically illustrates a part of the turbomachine 2, centred on an assembly comprising a turbine casing 20 circumferentially surrounding the low-pressure turbine 12, an exhaust casing 22 as an axial extension and downstream of the turbine casing 20, and an element 24 for fastening the exhaust casing 22 to the turbine casing 20.

The axial direction is the direction along the longitudinal dimension of the turbomachine 2, the radial direction being orthogonal to the axial direction, the circumferential direction corresponding to the direction of rotation of the first shaft 4.

The upstream and downstream sides are considered along the flow direction of hot gases derived from the combustion chamber 16 of the turbomachine 2 The low-pressure turbine 12 comprises several turbine stages each comprising an annular row of fixed vanes 26 and an annular row of moving vanes 28 rotating inside the turbine casing 20. The fixed and moving vanes 26, 28 each comprise an inner platform 30 and an outer platform 32.

The inner platforms 30 and outer platforms 32 define a flow path 34 for hot gases derived from the combustion chamber 16 of the turbomachine 2.

The outer platforms 32 of the moving vanes 28 comprise wipers 36 axially spaced apart from each other and extending radially outwardly.

The fixed vanes 26 are fastened by hooks to rails (not represented) of the turbine casing 20.

The turbine casing 20 of the assembly is provided with a plurality of abradable ring supports 37, each supporting an abradable ring 38, especially a sectorised abradable ring 38. Each abradable ring support 37 extends radially inwardly from the inner surface of the turbine casing 20 such that each abradable ring 38 is facing the wipers 36 of an outer platform 32 of a moving vane 28. The abradable rings 38 cooperate with the wipers 36 in order to participate in sealing the flow path 34.

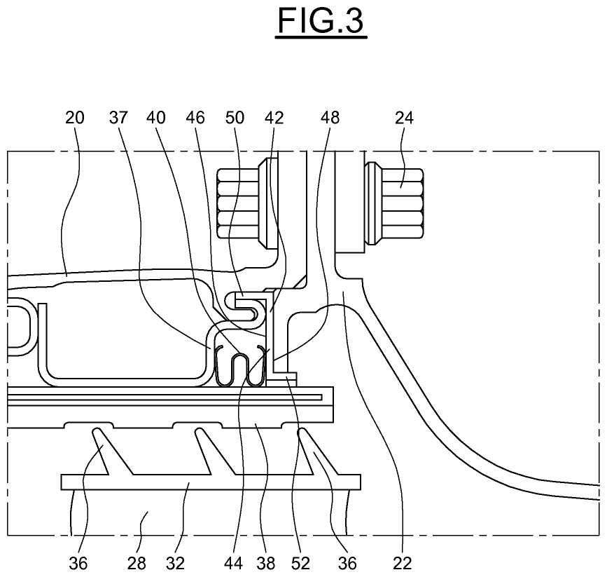

The assembly also comprises an annular seal 40, visible in more detail in FIG. 3, disposed between the exhaust casing 22 and an abradable ring support 37 of the turbine casing 20 in order to ensure sealing, especially thermal sealing, of the flow path 34 at the junction between the exhaust casing 22 and the turbine casing 20.

More precisely, the annular seal 40 surrounds, in the circumferential direction of the turbomachine 2, the abradable ring 38 facing the wipers 36 of the outer platform 32 of the moving vane 28 located most downstream of the low-pressure turbine 12. The annular seal 40 here comprises a lower-case omega-shaped section, the annular seal 40 comprising two convolutions.

The annular seal 40 is in contact on the upstream side with the abradable ring support 37 most downstream of the low-pressure turbine.

The annular seal 40 axially extends from the most downstream abradable ring support 37 of the low-pressure turbine 12 to the exhaust casing 22.

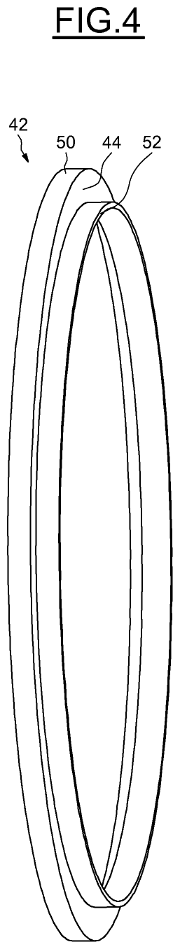

The assembly comprises a sealing element 42, also represented in FIG. 4, partly disposed between the annular seal 40 and the exhaust casing 22.

The sealing element 42 comprises an annular component 44 surrounding the first shaft 4 in the circumferential direction and axially disposed between the annular seal 40 of the assembly and the exhaust casing 22 of the assembly. The annular component 44 here extends purely radially.

The annular component 44 is provided with a first face 46, on the upstream side of the turbomachine 2, in contact with the annular seal 40.

The annular component 44 is provided with a second face 48, on the downstream side of the turbomachine 2, in contact with the exhaust casing 22.

The sealing element 42 cooperates with the annular seal 40 in order to ensure sealing of the flow path 34 at the junction between the turbine casing 20 and the exhaust casing 22.

The thickness of the annular component 44, along the longitudinal dimension of the turbomachine 2, increases axial stress on the annular seal 40. As the annular seal 40 is further compressed, the wear tolerance at the axial ends of the annular seal 40, especially without compromising thermal sealing, is increased.

The annular component 44 serves to protect the exhaust casing 22 from contact with the annular seal 40, especially from friction of the annular seal 40.

The sealing element 42 comprises, for example, a nickel-based alloy, especially in order to have a high resistance to corrosion, oxidation and high temperatures that are characteristic of the environment of the turbomachine 2.

Advantageously, the sealing element 42 comprises a first centring portion 50, or large-diameter centring portion 50, axially extending from the large-diameter edge of the annular component 44, the first centring portion 50 here extending upstream of the turbomachine 2 and away from the annular seal 40. The first centring portion 50 here extends purely axially. Alternatively, the first centring portion 50 could extend both axially and radially, and/or could extend downstream of the turbomachine 2.

The turbine casing 20 comprises a wall with a complementary shape to the first centring portion 50, in contact with the first centring portion 50. Said wall especially forms radial stops radially retaining the sealing element 42.

Advantageously, the sealing element 42 comprises a second centring portion 52, or small-diameter centring portion 52, axially extending from the small-diameter edge of the annular component 44, the second centring portion 52 here extending downstream of the turbomachine 2. The second centring portion 52 here extends purely axially. Alternatively, the second centring portion 52 could extend both axially and radially, and/or could extend upstream of the turbomachine 2.

The second centring portion 52 is radially bearing against the exhaust casing 22 in order to radially retain the sealing element 42.

The first and second centring portions 50 and 52 are here annular. Alternatively, the sealing element 42 comprises several centring portions spaced apart from each other in the circumferential direction, these centring portions thereby forming centring tabs.

The sealing element 42 is a less expensive and easier-to-replace consumable than the exhaust casing 22.

Optionally, the turbomachine 2 comprises an additional sealing element (not represented) of the same kind as the sealing element 42, and at least partly disposed between the turbine casing 20 and the annular seal 40, especially at least partly disposed between the abradable ring support 37 most downstream of the low-pressure turbine 12, and the annular seal 40, or at least partly disposed between a casing of the turbomachine 2 and another annular seal 54 of the turbomachine 2. Said other annular seal 54 is, for example, disposed at the junction between the low-pressure turbine 12 and the high-pressure turbine 18, said annular seal 54 and the additional sealing element together ensuring sealing of the flow path 34 at the junction between the turbine casing 20 and a casing that circumferentially surrounds the high-pressure turbine 18.

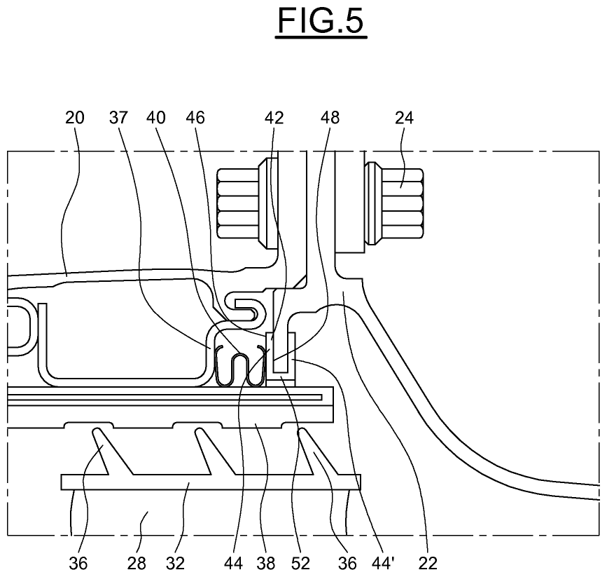

The second exemplary embodiment illustrated in FIG. 5 differs from the first exemplary embodiment illustrated in FIGS. 1 to 4 in that the sealing element 42 is free of the large-diameter centring portion and is additionally provided with an additional annular piece 44′ that is connected to the annular piece 44 by the small-diameter centring portion 52, and which extends away from and facing the annular piece 44. The additional annular component 44′ is here identical to the annular component 44. Alternatively, the additional annular component 44′ could extend both axially and radially, that is to say, obliquely, towards the annular component 44.

More precisely, the small-diameter centring portion 52 extends, on the one hand, axially and downstream from the small-diameter edge of the annular component 44, and on the other hand, axially and upstream from the small-diameter edge of the additional annular component 44′. The small-diameter centring portion 52 here extends purely axially.

The annular component 44 is axially in contact with the annular seal 40 and with the exhaust casing 22.

The small-diameter centring portion 52 is radially in contact with the exhaust casing 22. In particular, the external diameter of the small-diameter centring portion 52 is larger than the internal diameter of the exhaust casing 22, so that the small-diameter centring portion 52 is pressed against the exhaust casing 22 and dose not move during the operation of the turbomachine 2.

The additional annular component 44′ is provided with an upstream face that is axially in contact with the exhaust casing 22.

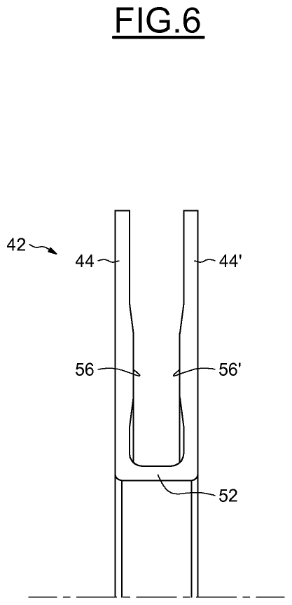

The third exemplary embodiment illustrated in FIG. 6 differs from the second exemplary embodiment illustrated in FIG. 5 in that both the annular component 44 and the additional annular component 44′ are of variable thickness. In particular, the annular component 44 and additional annular component 44′ each comprise a thickened section 56, 56′ so as to locally reduce the axial distance between the annular component 44 and the additional annular component 44′.

The thickened section 56 of the annular component 44 is formed away from the radially external end of the annular component 44 and away from the small-diameter centring portion 52. Similarly, the thickened section 56′ of the additional annular component 44′ is formed away from the radially external end of the additional annular component 44′ and away from the small-diameter centring portion 52. Thus, the sealing element 42 is clamped onto the exhaust casing 22, with the thickened sections 56 and 56′ in contact with the exhaust casing 22.

1. A turbomachine assembly, the assembly comprising a first casing, a second casing, an abradable ring support carried by the first casing, an annular seal at least partly disposed between the abradable ring support and the second casing, and a sealing element at least partly disposed between the annular seal and the second casing, the sealing element comprising an annular component provided with a first face in contact with the annular seal, and provided with a second face opposite to the first face in contact with the second casing.

2. The turbomachine assembly according to claim 1, wherein the sealing element comprises at least one large-diameter centring portion at least axially extending from a large-diameter edge of the annular component.

3. The turbomachine assembly according to claim 2, wherein said large-diameter centring portion is in contact with the first casing.

4. The turbomachine assembly according to claim 1, wherein the sealing element comprises at least one small-diameter centring portion at least axially extending from a small-diameter edge of the annular component.

5. The turbomachine assembly according to claim 4, in which the small-diameter centring portion is in contact with the second casing.

6. The turbomachine assembly according to claim wherein the large-diameter centring portion at least axially extends from the large-diameter edge of the annular component along a first direction, and the small-diameter centring portion at least axially extends from the small-diameter edge of the annular component along a second direction, the first direction being opposite to the second direction.

7. The turbomachine assembly according to claim wherein the sealing element further comprises an additional annular component that is connected to the annular component by said small-diameter centring portion, and which extends away from and facing the annular component.

8. The turbomachine assembly according to claim 7, wherein the additional annular component is in contact with the second casing.

9. The turbomachine assembly according to claim 7, in which the annular component comprises a thickened section, the additional annular component comprising a thickened section, said thickened sections locally reducing the distance between the annular component and the additional annular component.

10. The turbomachine assembly according to claim 1, wherein the first casing is a low-pressure turbine casing for a turbomachine and/or wherein the second casing is an exhaust casing for a turbomachine.

11. The turbomachine assembly according to claim comprising an abradable ring mounted to the abradable ring support, the annular seal comprising at least two convolutions and partly circumferentially surrounding the abradable ring.

12. The turbomachine assembly according to claim 1, wherein the sealing element comprises a nickel-based alloy.

13. A sealing element adapted for a turbomachine assembly according to claim 1, the sealing element being intended to be at least partly disposed between the annular seal and the second casing, the sealing element comprising an annular component provided with a first face intended to be in contact with the annular sealing element, and provided with a second face opposite to the first face intended to be in contact with the second casing, the sealing element comprising at least one first centring portion at least axially extending from a large-diameter edge of the annular component along a first direction and at least one second centring portion at least axially extending from a small-diameter edge of the annular component along a second direction, the first direction being opposite to the second direction.

14. A sealing element adapted for a turbomachine assembly according to claim 1, the sealing element being intended to be at least partly disposed between the annular seal and the second casing, the sealing element comprising an annular component provided with a first face intended to be in contact with the annular seal, and provided with a second face opposite to the first face intended to be in contact with the second casing, the sealing element comprising at least one small-diameter centring portion at least axially extending from a small-diameter edge of the annular component and an additional annular component which is connected to the annular component by said small-diameter centring portion, and which extends away from and facing the annular component.

15. The sealing element adapted for a turbomachine assembly according to claim 14, wherein the annular component comprises a thickened section, the additional annular component comprising a thickened section, said thickened sections locally reducing the distance between the annular component and the additional annular component.
